(19) United States
(12) Patent Application Publication
(10) Pub. No.: US 2009/0077827 A1
(43) Pub. Date: Mar. 26, 2009

(54) DRYER AND METHOD OF CONTROLLING FOR THE SAME

(76) Inventor: Young Jin Doh, Jinhae-si (KR)

Correspondence Address: BIRCH STEWART KOLASCH & BIRCH, PO BOX 747, FALLS CHURCH, VA, 22040-0747, US

(21) Appl. No.: 12/297,601

(22) PCT Filed: Apr. 16, 2007
(86) PCT No.: PCT/KR2007/001826

§ 371 Date: Oct. 17, 2008

(30) Foreign Application Priority Data
Apr. 17, 2006 (KR) 10-2006-0034726

(51) Int. Cl. F26B 3/02; D06F 58/04; F26B 21/00; F26B 19/00

(52) U.S. Cl. 34/486; 34/132; 34/82; 34/562

(57) ABSTRACT

The present invention provides a dryer and a method for controlling the same, which prevents foreign matters from entering into a heater and can remove the foreign matters from the heater. The dryer includes a drum for holding a drying object, a heater for heating air to provide hot air to the drum, a duct for forming a flow passage for introducing the hot air heated at the heater to the drum, a fan for controlling an air flow in the duct, and a microcomputer for controlling operation of the fan and the heater for removing foreign matters accumulated on the heater. The method for controlling a dryer having a heater and a fan includes the steps of a foreign matter removing step for removing foreign matters from the heater by driving the fan in a state the heater is not operated, and a drying course step for performing a drying course by driving the heater after the foreign matter removing step.

### TECHNICAL FIELD

The present invention relates to dryers. More specifically, the present invention relates to a dryer which can prevent dust or lint formed in a drying course from carbonizing to cause fire, or damage heater, and a method for controlling the same.

### BACKGROUND ART

A laundry handling apparatus, such as a laundry dryer, automatically dries a wet drying object. The laundry dryer dries the object by a process in which an object in a drum where the drying object is positioned is heated directly or indirectly, to vaporize liquid from the object, and the vapor is discharged to an outside of the drum.

Since a method of object direct heating is liable to cause serious deformation of the object, a method is used mostly, in which an inside temperature of the drum is elevated or air is heated with the heater to produce hot air, and introduced into the drum, for drying the object.

In the methods of drying the laundry with the hot air, there are exhaust type laundry dryers and condensing type laundry dryers depending on methods for disposing humid air produced in drying the drying object.

In an exhaust type drying, external air is introduced to the drum, to produce hot air, and humid air is discharged from the drum to an outside of the drum, and in the condensing type drying, air is circulated through an inside of the drum for drying without introduction of the external air, wherein humid air from the drum is condensed at a condenser to remove moisture from the humid air to produce dry air, and the dry air is heated again, and introduced into the drum.

In general, the dryer with hot air is provided with a drum for holding and drying the drying object, a duct connected both to an inlet opening which introduces air to the drum, and an outlet opening which discharges air from the drum, to form a flow passage, a fan for blowing air from the drum and the duct, and a heater for heating the air to provide hot air.

### DISCLOSURE OF INVENTION

### Technical Problem

However, the related art dryer has the following problems.

Dust and lint produced in a process of drying the laundry in the dryer is carbonized when the dust and lint is brought into contact with the heater to cause, not only fire, but also damage the heater.

### Technical Solution

To solve the problems, the present invention provides a dryer which can prevent a foreign matter from introducing into a heater, and remove the foreign matter from accumulating on the heater, and a method for controlling the same.

According to the present invention, as embodied and broadly described herein, a dryer includes a drum for holding a drying object, a heater for heating air to provide hot air to the drum, a duct for forming a flow passage for introducing the hot air heated at the heater to the drum, a fan for controlling an air flow in the duct, and a microcomputer for controlling operation of the fan and the heater for removing foreign matters accumulated on the heater.

The microcomputer may control such that the fan is operated in a state the heater is not operated. Preferably, the control of the microcomputer is made at an initial stage of a drying course for a predetermined time period.

The dryer may further include a filter for preventing the foreign matters from entering into the heater.

Preferably, the filter is mounted to at least any one of a suction opening through which the air is introduced into the drum, and a discharge opening through which the air is discharged from the drum. In a case of an exhaust type dryer, it is preferable that the filter is mounted to the suction opening through which the air is introduced into the drum.

Moreover, the filter may be mounted to a housing of the heater.

In another aspect of the present invention, a method for controlling a dryer having a heater and a fan includes the steps of a foreign matter removing step for removing foreign matters from the heater by driving the fan in a state the heater is not operated and a drying course step for performing a drying course by driving the heater after the foreign matter removing step.

Preferably, the foreign matter removing step is made at an initial stage of the drying course for a predetermined time period.

### BRIEF DESCRIPTION OF THE DRAWINGS

FIG. 1 illustrates a longitudinal section of a condensing type dryer in accordance with a preferred embodiment of the present invention.

FIG. 2 illustrates a flow chart showing the steps of a method for controlling a dryer which is conducted with the condensing type dryer in accordance with a preferred embodiment of the present invention.

### BEST MODE FOR CARRYING OUT THE INVENTION

Reference will now be made in detail to the specific embodiments of the present invention, examples of which are illustrated in the accompanying drawings. Though the present invention is described taking a condensing type dryer as an example, the description is merely an embodiment of the present invention in one aspect of the present invention, and the aspect of the present invention is applicable to other dryers, for an example, to exhaust type dryers.

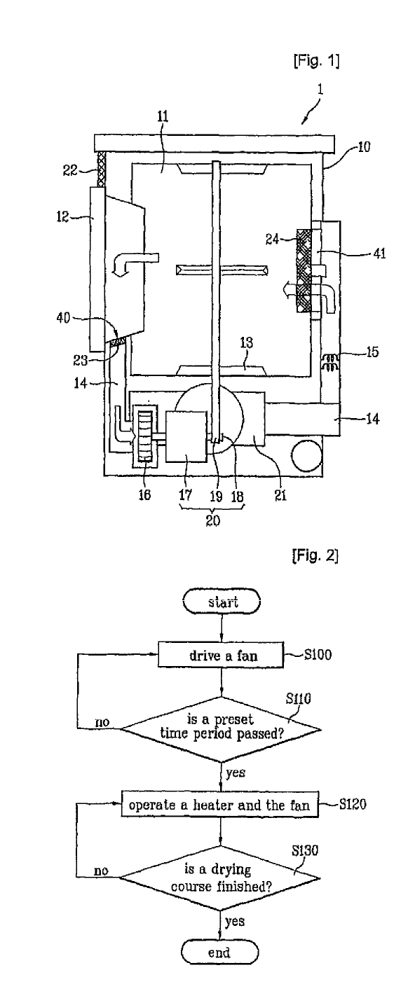

FIG. 1 illustrates a longitudinal section of a condensing type dryer in accordance with a preferred embodiment of the present invention, and FIG. 2 illustrates a flow chart showing the steps of a method for controlling a dryer which is conducted with the condensing type dryer in accordance with a preferred embodiment of the present invention.

Referring to FIG. 1, the condensing type dryer 1 includes a body 10, a drum 11 mounted in the body 10 for holding a drying object, a heater 15 for heating air to provide hot air to the drum 11, a duct 14 for forming a flow passage of the hot air from the heater 15 to the drum 11, a fan 16 for controlling air flow through the duct 14, and a microcomputer for controlling operation of the fan 16 and the heater 15 to remove foreign matters from the heater 15.

The condensing type heater 1 may also include filters 23 and 24 for preventing foreign matters from entering into the heater 15, and a control panel 22 for enabling a user to input an order for starting or stopping a course of the dryer.

In detail, the body 10 has a door 12 in a front, and components of the dryer 1 mounted therein, for protecting the components from an external environment.

The drum 11 forms a space for holding laundry which is a drying object, for drying the laundry. Accordingly, in a drying course, the drying object is brought into contact with the hot air in the drum 11. The drum 11 has an air suction opening 41 for introducing air from the duct 14 to the drum 11, and an air discharge opening 40 for discharging air from the drum 11 to the duct 14.

The drum 11 is provided in a structure which is fixedly, or movably secured. In a case the drum 11 is fixedly secured a structure may be provided in the drum 11 which permits the user to spread and hang the object from the structure. In a case the drum 11 is movably secured the drum 11 may be provided as a rotatable structure.

Referring to FIG. 1, the condensing type dryer 1 has the drum 11 rotatably mounted in the body 10, with a plurality of lifters 13 projected from an inside circumferential surface. The drum 11 is connected to driving means 20 which provides a rotating power. Therefore, the drum 11 is rotated as the driving means 20 is operated and the drying object is rotated and mixed with the hot air by the lifters 13.

The driving means 20 which rotates the drum 11 includes a motor 17, and a driving belt 19 connected to a driving pulley 18 connected to the motor 17 as well as wound around an outside circumferential surface of the drum 11. Therefore, if the driving pulley 18 rotates by rotation of the motor 17, the belt 19 wound on the driving pulley 18 rotates to rotate the drum 11.

The duct 14 forms a flow passage in the dryer. As can be seen from the embodiment, in a case of the condensing type dryer 1, the duct 14 may form one flow passage which connects the discharge opening 40 to the suction opening 41. However, in a case of an exhaust type dryer, the duct 14 may include separate ducts of a duct connected to the discharge opening 40 for discharging the air to an outside of the dryer, and a duct connected to the suction opening 41 for introducing air into the drum 11.

The fan 16 is mounted in the duct 14 or adjacent to the duct 14, for making an air flow both in the drum 11 and the duct 14 smooth, and controlling a direction and strength of the air flow. As shown in FIG. 1, in the condensing type dryer 1 of the embodiment of the present invention, the fan 16 is mounted in rear of the discharge opening 40.

The heater 15 is mounted in the duct 14 for heating the air being introduced to the drum 11 to produce hot air. Preferably, the heater 15 is mounted close to the suction opening 41.

The filter 23 and 24 for preventing foreign matters from entering into the duct 14 and the heater 15, may be mounted to at least one of the discharge opening 40 and the suction opening 41. Particularly, in a case of the exhaust type dryer, it is preferable that the filter 23 and 24 is mounted to the suction opening 41. This is because, in the exhaust type dryer, the air discharged from the discharge opening 40 is not introduced to the heater 15, directly.

In a case of the condensing type dryer 1, it is preferable that a lint filter 23 is mounted to the discharge opening 40 and a heater filter 24 is mounted to the suction opening 41.

The lint filter 23 is mounted to the discharge opening 40 for filtering foreign matters greater than a predetermined size from the air form the drum 11. Accordingly, air that contains no foreign matters, or only foreign matters of sizes that can be burnt completely owing to a high temperature of the heater 15 can be supplied from the discharge opening 40 to the heater 15.

The heater filter 24 is mounted to the suction opening 41.

The foreign matters formed in the drying course moves to the heater 15 through the suction opening 41 or accumulated by vortex generated in the drum 11 and the vicinity of the suction opening 41. The heater filter 24 is mounted to the suction opening 41 for preventing the foreign matters from entering through the suction opening 41. It is preferable that the heater filter 24 has a grating shape for preventing the heater filter 24 from having poor efficiency.

The control panel 22 receives a user's order on starting or stopping of the course, and provides the order to the microcomputer.

The microcomputer controls to operate the fan 16 and the heater 15 to remove the foreign matters from the heater 15. Preferably, By controlling such that the fan 16 is operated in a state the heater 15 is not operated the microcomputer can make the foreign matters to be removed from the heater 15 before the heater 15 is operated.

Though the control of the microcomputer can be made in the middle of the drying course of the dryer, it is more preferable that the control of the microcomputer is made for a predetermined time period of an initial stage of the drying course. For an example, a course for removing the foreign matters from the heater 15 may be made for about 2 seconds at the initial stage of the drying course. Then, the course for removing the foreign matters from the heater 15 can remove the dust from the heater 15 while the course does not interfere the drying course of the dryer. If it is a case when the heater filter 24 is mounted to the suction opening 41, not only the foreign matters from the heater 15, but also the foreign matters from the heater filter 24 can be removed.

The operation of the condensing type dryer 1 in accordance with a preferred embodiment of the present invention will be described.

When the user of the dryer 1 inputs a course starting order to the dryer 1 through the control panel 22 after introducing the drying object into the drum 1 of the dryer 1, and closing the door 12 for drying the wet drying object, the drying course by using hot air, and a fire prevention method are started.

By the course starting order, the motor 17 is driven, to rotate the fan 16 and the drum 11 and operate the heater 15. Then, the air flowing through the duct 14 according to this is heated with the heater 15 to hot air, and introduced into the drum 11 through the suction opening 41.

The hot air introduced into the drum 11 is mixed with the drying object, and discharged through the discharge opening 40. The humid and high temperature air discharged thus is condensed into dry air at the condenser 21 by heat exchange, heated at the heater 15 again, and introduced into the drum 11.

FIG. 2 illustrates a flow chart showing the steps of a method for controlling a dryer which is conducted with the condensing type dryer in accordance with a preferred embodiment of the present invention.

The drying course and a method for preventing fire will be described with reference to FIG. 2.

Upon receiving a starting order of course of the dryer 1, the microcomputer conducts a foreign matter removal step (S100) in which the microcomputer puts the fan 16 into operation, to blow foreign matters away from the filter 24 and the heater 15.

In the foreign matter removal step (S100), the microcomputer determines whether a driving time period of the fan 16 is passed a preset time period (for an example, 2 seconds) or not (S110).

If the driving time period of the fan 16 is passed the preset time period the microcomputer applies power to the heater 15, to heat the heater for performing a drying course step (S120) in which both the heater 15 and the fan 16 are operated.

After the drying course step (S120), the microcomputer determines whether the drying course is finished or not (S130), and if the drying course is not finished the microcomputer controls to perform the drying course step (S120) continuously, and if the drying course is finished the microcomputer ends entire course.

Eventually, because the fan 16 and the heater 15 are controlled to blow the foreign matters from the heater 15 at an initial stage of the course before heating the heater 15, the control method enables, not only to prevent the heater 15 from suffering from damage caused by carbonization of the foreign matters, but also to solve difficulty of cleaning of the filter 24 at the suction opening 41 due to structure of the dryer 1 because the foreign matters on the filter 24 at the suction opening 41 are also removed.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The present invention relates to dryers. More specifically, the present invention relates to a dryer which can prevent dust or lint formed in a drying course from carbonizing to cause fire, or damage heater, and a method for controlling the same.

The present invention permits to remove foreign matters such as dust and lint formed in a course of laundry drying from the heater at an initial stage of the course before heating the heater by controlling the fan and the heater.

Accordingly, not only damage to the heater caused by carbonization of the foreign matters accumulated on the heater can be prevented but also the difficulty of cleaning of the filter due to a structure of the dryer can be solved because the foreign matters on the filter at the suction opening is also removed.

1. A dryer comprising:
a drum for holding a drying object;
a heater for heating air to provide hot air to the drum;
a duct for forming a flow passage for introducing the hot air heated at the heater to the drum;
a fan for controlling an air flow in the duct; and
a microcomputer for controlling operation of the fan and the heater for removing foreign matters accumulated on the heater.

2. The dryer as claimed in claim 1, wherein the microcomputer controls such that the fan is operated in a state the heater is not operated.

3. The dryer as claimed in claim 2, wherein the control of the microcomputer is made at an initial stage of a drying course for a predetermined time period.

4. The dryer as claimed in claim 1, further comprising a filter for preventing the foreign matters from entering into the heater.

5. The dryer as claimed in claim 4, wherein the filter is mounted to at least any one of a suction opening through which the air is introduced into the drum, and a discharge opening through which the air is discharged from the drum.

6. The dryer as claimed in claim 4, wherein the filter is mounted to the suction opening through which the air is introduced into the drum.

7. The dryer as claimed in claim 4, wherein the filter is mounted to a housing of the heater.

8. A method for controlling a dryer having a heater and a fan comprising the steps of:
a foreign matter removing step for removing foreign matters from the heater by driving the fan in a state the heater is not operated; and
a drying course step for performing a drying course by driving the heater after the foreign matter removing step.

9. The method as claimed in claim 8, wherein the foreign matter removing step is made at an initial stage of the drying course for a predetermined time period.
